(19) United States
(12) Patent Application Publication
(10) Pub. No.: US 2025/0284401 A1
(43) Pub. Date: Sep. 11, 2025

(54) MEMORY SYSTEM AND METHOD OF MANAGING ADDRESSES OF A MEMORY SYSTEM

(71) Applicant: SK hynix Inc., Icheon-si Gyeonggi-do (KR)

(72) Inventor: Byoung Sung YOU, Icheon-si Gyeonggi-do (KR)

(73) Assignee: SK hynix Inc., Icheon-si Gyeonggi-do (KR)

(21) Appl. No.: 19/013,590

(22) Filed: Jan. 8, 2025

(30) Foreign Application Priority Data
Mar. 11, 2024 (KR) 10-2024-0033741

(51) Int. Cl. G06F 3/06

(52) U.S. Cl. CPC G06F 3/0611; G06F 3/0656; G06F 3/0679

(57) ABSTRACT

A memory system include a memory device including a plurality of sequential areas in which data corresponding to consecutive logical addresses received from a host device are stored, and a memory controller for receiving, from the host device, a write request including the data and the logical addresses, grouping the plurality of sequential areas into a plurality of sequential area groups based on a program speed corresponding to each of the plurality of sequential areas, and mapping each of the logical addresses to one of the plurality of sequential area groups based on an access number and an access time of the data.

### CROSS-REFERENCE TO RELATED APPLICATION

The present application claims priority under 35 U.S.C. § 119(a) to Korean patent application number 10-2024-0033741 filed on Mar. 11, 2024, in the Korean Intellectual Property Office, the entire contents of which application is incorporated herein by reference.

### BACKGROUND

### 1. Technical Field

The present disclosure generally relates to a memory system, including but not limited to a memory system and a method for managing addresses of the memory system.

### 2. Related Art

A memory device is classified as a volatile memory device or a nonvolatile memory device. A volatile memory device is a memory device in which data is stored only when power is supplied, and stored data is no longer stored when the supply of power is interrupted. A nonvolatile memory device is a memory device in which data remains stored even when the supply of power is interrupted.

A semiconductor memory device includes a plurality of memory cells for storing data. Three-dimensional memory devices have increased integration density for memory cells. Methods of reading such memory cells are needed.

### SUMMARY

In accordance with the present disclosure, a memory system may include: a memory device including a plurality of sequential areas in which data corresponding to consecutive logical addresses received from a host device are stored; and a memory controller configured to receive, from the host device, a write request including the data and the consecutive logical addresses, to group the plurality of sequential areas into a plurality of sequential area groups based on a program speed corresponding to each of the plurality of sequential areas, and to map each of the logical addresses to one of the plurality of sequential area groups based on an access number and an access time of the data.

In accordance with the present disclosure, a method of operating a memory system may include: receiving, from a host device, a write request including consecutive logical addresses and data corresponding to the logical addresses to store the data in a memory device; grouping each of a plurality of sequential areas of the memory device into one of a hot group, a warm group, and a cold group based on a program speed corresponding to each of the plurality of sequential areas; and mapping each of the logical addresses to one of the hot group, the warm group, and the cold group based on an access number and an access time of the data.

In accordance with the present disclosure, a method may include receiving a write request including logical addresses and data corresponding to the logical addresses to store the data in a memory device; grouping, based on a program speed corresponding to each of a plurality of sequential areas of the memory device, each of the plurality of sequential areas into one of a plurality of sequential area groups; and mapping each of the logical addresses to one of the sequential area groups based on frequency of use of the data.

### BRIEF DESCRIPTION OF THE DRAWINGS

FIG. 1 is a diagram illustrating a memory system in accordance with an embodiment of the present disclosure.

FIG. 2 is a diagram illustrating an address re-ordering operation and a mapping operation in accordance with an embodiment of the present disclosure.

FIG. 3 is a diagram illustrating a program speed difference between sequential areas included in a memory device in accordance with an embodiment of the present disclosure.

FIG. 4 is a diagram illustrating sequential areas and sequential area groups of a memory block in accordance with an embodiment of the present disclosure.

FIG. 5 includes tables showing sequential areas mapped to logical addresses in accordance with an embodiment of the present disclosure.

FIG. 6 includes tables showing logical addresses stored in a page buffer in accordance with an embodiment of the present disclosure.

FIG. 7 includes tables showing re-ordering of logical addresses in accordance with an embodiment of the present disclosure.

FIG. 8 is a flowchart illustrating a method of performing a write operation in accordance with an embodiment of the present disclosure.

FIG. 9 is a flowchart illustrating logical address re-ordering performance in accordance with an embodiment of the present disclosure.

### DETAILED DESCRIPTION

Embodiments of the present disclosure are described detail with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

In the drawing figures, dimensions may not be precise for clarity of illustration. When one element is identified as “connected” to another element, the elements may be connected directly or through at least one intervening element between the elements. When two elements are identified as “directly connected” one element is directly connected to the other element without an intervening element between the two elements. Terms such as “horizontal,” “top,” “bottom,” “upper,” “lower,” “higher,” and other terms implying relative spatial relationship or orientation are utilized only for the purpose of ease of description or reference to a drawing and are not otherwise limiting.

Memory devices includes sequential areas. Logical addresses corresponding to the sequential areas are typically consecutive. A sequential area may be allocated to each application. Program speeds of sequential areas may vary. When a program speed of a sequential area allocated to a frequently used application is relatively low, write performance may be lowered. A memory system and a method for managing addresses of the memory system are described in which sequential areas having a high program speed are mapped to data having a high use frequency when a write operation of the memory system is performed, thereby improving write performance.

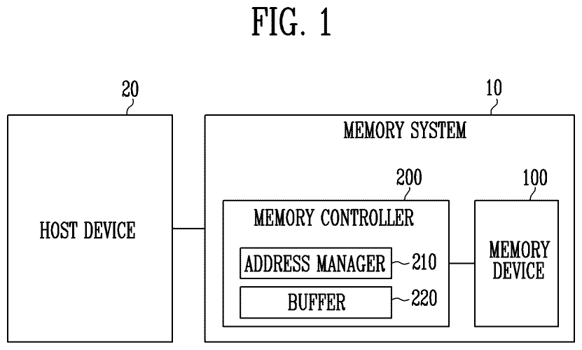

FIG. 1 is a diagram illustrating a memory system in accordance with an embodiment of the present disclosure.

Referring to FIG. 1, the memory system 10 includes a memory device 100 and a memory controller 200 that controls an operation of the memory device 100. The memory system 10 is a device that stores data under the control of a host device 20 such as a mobile phone, a smartphone, an MP3 player, a laptop computer, a desktop computer, a game console, a TV, a tablet PC, an in-vehicle infotainment system, and so forth. The memory system 10 is connected to the host device 20.

The memory device 100 stores data. The memory device 100 operates under control of the memory controller 200. The memory device 100 includes a memory cell array including a plurality of memory cells that store data.

The memory device 100 receives a command and an address from the memory controller 200 and accesses an area selected by the address in the memory cell array. The memory device 100 performs an operation indicated by the command on the area selected by the address.

In an embodiment of the present disclosure, the memory device 100 includes a plurality of sequential areas in which data corresponding to consecutive logical addresses provided from the host device 20 are stored. The sequential areas are areas in which Logical Block Addresses (LBAs) are consecutive. The LBAs of the data stored in the sequential areas are consecutive. An LBA is designated as a logical address. Sizes of different sequential areas included in the memory device 100 may vary. The memory device 100 is divided into sequential areas.

The memory controller 200 controls overall operation of the memory system 10. The memory controller 200 controls the memory device 100 to perform a program operation, a read operation, an erase operation, and the like according to a request of the host device 20.

The memory controller 200 includes an address manager 210 and a buffer 220. The memory controller 200 receives a write request from the host device 20. The write request includes consecutive logical addresses and data corresponding to the logical addresses. The memory controller 200 generates a control signal corresponding to the received write request and transfers the generated control signal to the memory device 100.

The address manager 210 translates a logical address received from the host device 20 into a physical address indicating a position at which data is stored in the memory device 100. The physical address is expressed as a Physical Block Address (PBA). The address manager 210 maps a logical address to a physical address. The address manager 210 generates map data indicating a mapping relationship between a physical address and a logical address.

In an embodiment of the present disclosure, the address manager 210 stores, in the buffer 220, the data and the logical addresses, which are included in the write request received from the host device 20. The address manager 210 performs a re-ordering operation including changing a ranking of each of the logical addresses stored in the buffer 220 based on use frequency of the data.

The memory controller 200 groups the sequential areas included in the memory device 100 into sequential area groups. The memory controller 200 groups sequential areas into one of a hot group, a warm group, and a cold group according to a three-dimensional structure of the memory device. The memory controller 200 maps the re-ordered logical addresses to the sequential area groups.

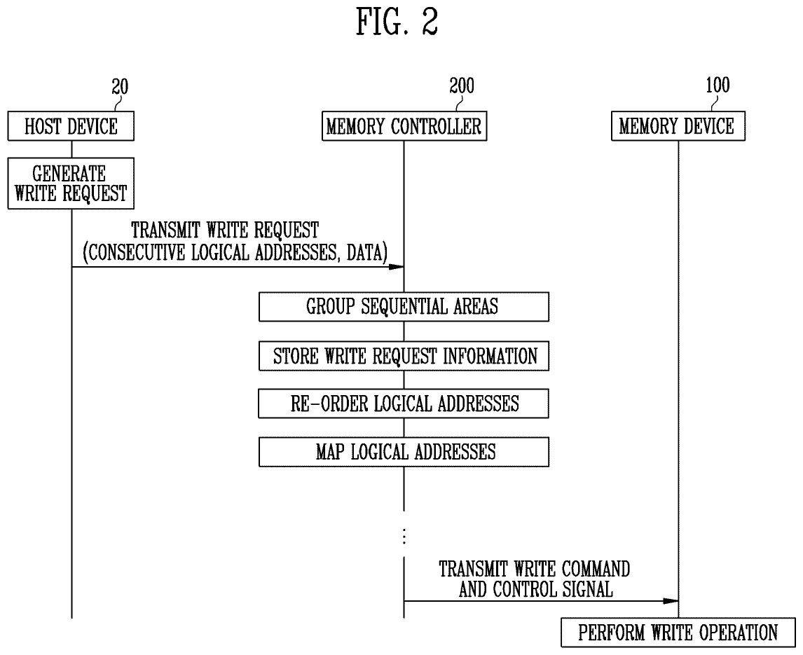

FIG. 2 is a diagram illustrating an address re-ordering operation and a mapping operation in accordance with an embodiment of the present disclosure.

Referring to FIG. 2, the host device 20 generates a write request, and the memory controller 200 re-orders received logical addresses based on the write request and maps the re-ordered logical addresses into sequential area groups. The memory controller 200 generates a control signal that controls the memory device 100 to perform a write operation corresponding to the write request based on a mapping result. The memory device 100 performs the write operation based on the control signal and a write command, which are received from the memory controller 200.

The host device 20 generates a write request including consecutive logical addresses and data corresponding to the logical addresses. The host device 20 transmits the write request to the memory controller 200.

The memory controller 200 receives the write request from the host device 20. The memory controller 200 groups a plurality of sequential areas included in the memory device 100 into sequential area groups based on program speed corresponding to each of the plurality of sequential areas. The memory controller 200 groups a first quantity of sequential areas as a hot group in an order in which the program speed is high among the plurality of sequential areas, group a second quantity of sequential areas as a cold group in an order in which the program speed is low among the plurality of sequential area, and group, as a warm group, the other sequential areas that are not included in the hot group or the cold group among the plurality of sequential areas. In an embodiment of the present disclosure, quantities of sequential areas included in different sequential area groups may vary.

The memory controller 200 stores, in the buffer 220, write request information received from the host device 20. The write request information includes consecutive logical addresses and data. In an embodiment of the present disclosure, the memory controller 200 counts how many times a logical address is received. The access number for the logical address represents a quantity of times the memory controller 200 receives the logic address from the host device 20, thus the access number reflects a frequency of use of the data associated with a logical address.

The memory controller 200 stores, in the buffer 220, logical addresses in an order in which the logical addresses are received from the host device 20. The memory controller 220 performs a re-ordering operation including determining a ranking of each of the logical addresses stored in the buffer 220, based on an access number and an access time of data.

The memory controller 200 determines a ranking of each of the logical addresses in an order in which the highest access number has the highest ranking. When access numbers of multiple logical addresses are the same, the memory controller 200 determines a higher ranking for a logical address received last, or most recently received, from the host device 20 among the multiple logical addresses having the same access number. The memory controller 200 preferentially considers the access number from the access number and the access time when access numbers of multiple logical addresses are the same.

The memory controller 200 maps to the hot group a first quantity of logical addresses in an order in which the ranking is highest among the re-ordered logical addresses. The memory controller 200 maps to the cold group a second quantity of logical addresses in an order in which the ranking is lowest among the re-ordered logical addresses, and maps the other logical addresses, for example, those not mapped to the hot group or the cold group, to the warm group.

In another embodiment of the present disclosure, the memory controller performs the re-ordering operation based on a size or a characteristic of data. The memory controller 200 maps logical addresses corresponding to the data to the hot group when the size of the data is smaller than a first limit value, and maps the logical addresses corresponding to the data to the cold group when the size of the data is greater than a second limit value greater or larger than the first limit value. The memory controller 200 may map logical addresses to the hot group, the warm group, or the cold group, based on whether the data included in the write request is journal data, firmware data, or map data.

In an embodiment of the present disclosure, the memory controller 200 continues to receive write requests from the host device 20 until the quantity of logical addresses stored in the buffer 220 reaches a predetermined quantity. The memory controller 200 performs an operation including storing logical addresses in the buffer 220 and a re-ordering operation and a mapping operation on the stored logical addresses with respect to the received write requests. The memory controller 200 generates a control signal that is transmitted to the memory device 100 when the quantity of logical addresses stored in the buffer 220 reaches the predetermined quantity.

The memory device 100 receives, from the memory controller 200, a write command and a control signal corresponding to the write request. The memory device 100 performs a write operation corresponding to the write request based on logical addresses mapped to the plurality of sequential area groups.

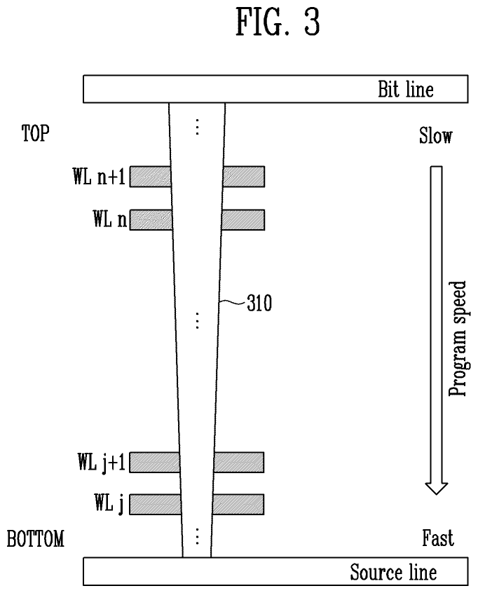

FIG. 3 is a diagram illustrating a program speed difference between sequential areas of the memory device in accordance with an embodiment of the present disclosure.

Referring to FIG. 3, a section of a cell string 310 including memory cells of the memory device 100 is illustrated. For convenience of description, only one cell string 310 is illustrated in FIG. 3, although a plurality of cell strings are included. The memory cells may be stacked in a three-dimensional structure. The cell string 310 may include an oxide in which the memory cells are stacked. An upper end TOP of the cell string 310 is in contact with a horizontally formed bit line and a lower end BOTTOM of the cell string 310 is in contact with a horizontally formed source line.

The cell string 310 includes a channel formed at the center of the cell string 310 and word lines surround the channel. In a three-dimensional memory cell stack structure, a thickness of the upper end TOP of the cell string 310 is thicker than a thickness of the lower end BOTTOM of the cell string 310. Program speeds of sequential areas of the memory cells are different from each other due to a thickness difference between the upper end TOP and the lower end BOTTOM. For example, a program speed of the upper end TOP having a greater thickness is slower than a program speed of the lower end BOTTOM having a lesser thickness. A program speed includes a write speed at which data is stored in a memory cell.

The memory controller 200 groups a plurality of sequential areas based on program speeds corresponding to the plurality of sequential areas. The memory controller 200 generates a hot group including sequential areas having a fast program speed among the plurality of sequential areas, a cold group including sequential areas having a slow program speed among the plurality of sequential areas, and a warm group including the sequential areas between the sequential areas of the hot group and the sequential areas of the cold group among the plurality of sequential areas.

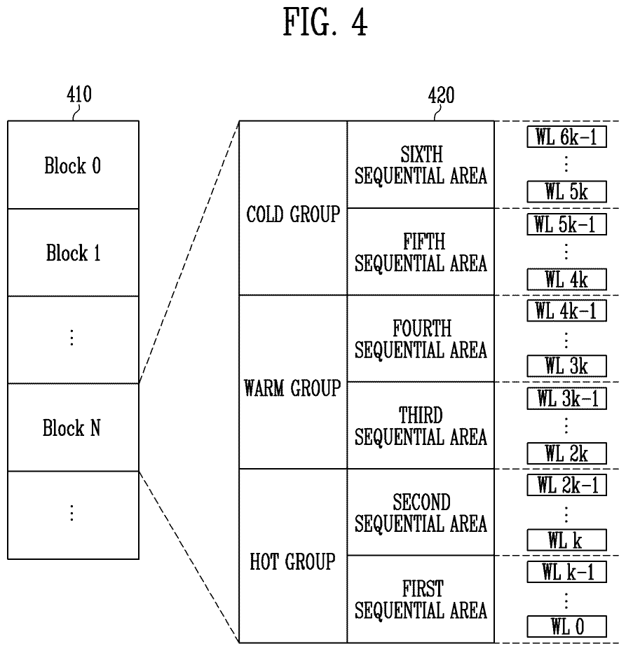

FIG. 4 is a diagram illustrating sequential areas and sequential area groups of a memory block in accordance with an embodiment of the present disclosure.

Referring to FIG. 4, memory blocks 410 included in the memory device 100 and sequential areas 420 mapped to an Nth memory block among the memory blocks are illustrated. For convenience of description, the quantity of sequential areas mapped to the Nth memory block is 6 and two sequential areas are included in each sequential area group. FIG. 4 is an example, and the quantity of sequential areas and the quantity of sequential areas included in each sequential area group may vary.

In FIG. 4, a first sequential area and a second sequential area are included in a hot group, a third sequential area and a fourth sequential area are included in a warm group, and a fifth sequential area and a sixth sequential area are included in a cold group. A program speed of the first sequential area among the first to sixth sequential areas is fastest, and a program speed of the sixth sequential area among the first to sixth sequential areas is slowest.

In FIG. 4, k word lines are mapped to each of the sequential areas 420, where k is a positive integer. In FIG. 4, the first sequential area is mapped to the zeroth to the (k−1) word lines, the second sequential area is mapped to the kth to the (2k−1) word lines, the third sequential area is mapped to the 2k to the (3k−1) word lines, the fourth sequential area is mapped to the 3k to (4k−1) word lines, the fifth sequential area is mapped to the 4k to the (5k−1) word lines, and the sixth sequential area is mapped to the 5k to the (6k−1) word lines.

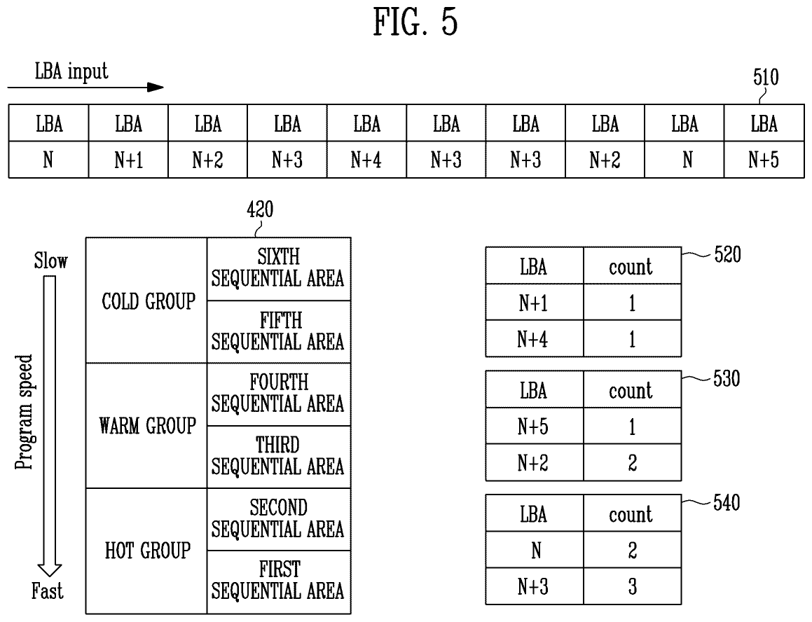

FIG. 5 includes tables showing sequential areas mapped to logical addresses in accordance with an embodiment of the present disclosure.

Referring to FIG. 5, ten logical addresses 510 received from the host device 20 and tables 520, 530, and 540 representing access numbers of the logical addresses are illustrated. In FIG. 5, the input logical addresses are examples, and the quantity and order of the input logical addresses may vary. In the example of FIG. 5, LBA N is input first and LBA N+5 is input last among the ten LBAs in table 510.

The memory controller 200 stores access numbers of the input logical addresses. In FIG. 5, each of LBAs N+1, N+4, and N+5 is input once, each of LBAs N+2 and N is input twice, and LBA N+3 is input three times. The memory controller 200 determines a ranking of each of the logical addresses according to order access number associated with the logical addresses. The memory controller 200 determines that the LBA N+3 has the largest access number and is assigned a first or highest ranking.

When access numbers of logical addresses are the same, the ranking of a last input logical address among logical addresses with the same access number is determined to have the higher ranking. The memory controller 200 determines, as a second ranking, the LBA N that is input ninth among the LBAs N and N+2 and determines that the LBA N+2 has a third ranking. The memory controller 200 determines that the LBA N+5 has a fourth ranking, determines that the LBA N+4 has a fifth ranking, and determines that the LBA N+1 has a sixth ranking based on an input order because the access numbers of these logical addresses are the same. The memory controller 200 performs a re-ordering operation including changing a ranking of each of the logical addresses stored in the buffer 220 according to the determined rankings.

In FIG. 5, re-ordered logical addresses are mapped to the sequential areas 420 shown in FIG. 4. The memory controller 200 maps the re-ordered logical addresses to the sequential area groups. In FIG. 5, the memory controller 200 maps the LBAs N+3 and N to the hot group, maps the LBAs N+2 and N+5 to the warm group, and maps the LBAs N+4 and N+1 to the cold group. The memory controller 200 maps sequential areas to logical addresses in each group. For example, the memory controller 200 maps the LBA N+3 to the first sequential area, maps the LBA N to the second sequential area, maps the LBA N+2 to the third sequential area, maps the LBA N+5 to the fourth sequential area, maps the LBA N+4 to the fifth sequential area, and maps the LBA N+1 to the sixth sequential area.

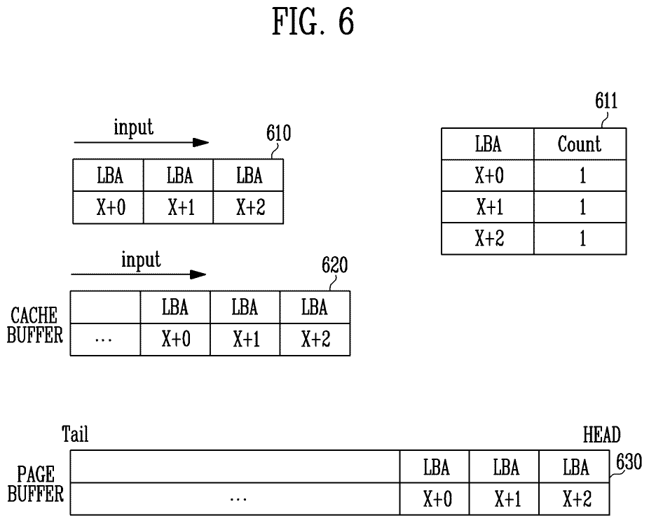

FIG. 6 includes tables showing logical addresses stored in a page buffer in accordance with an embodiment of the present disclosure.

Referring to FIG. 6, logical addresses 610 received from the host device 20 and a table 611 representing access numbers of the logical addresses are illustrated. In FIG. 6, an arrow indicates an order in which the logical addresses 610 are input.

The logical addresses 610 are input to the memory controller 200 in an order of LBA X+0, LBA X+1, and LBA X+2. The memory controller 200 stores the logical addresses 610 in a cache buffer 620 in an order in which the logical addresses 610 are received. Logical addresses different from the received logical addresses 160 may already be stored in the cache buffer 620.

The memory controller 200 re-orders a ranking of each of the logical addresses stored in the cache buffer 620 based on the table 611. The re-ordered logical addresses are stored in a page buffer 630. In FIG. 6, because access numbers of the LBA X+0, LBA X+1, and LBA X+2 are all the same, the ranking of each of the logical addresses is determined based on last received logical address, and the ranking of the LBA X+2 received last is highest, followed by LBA X+1, and LBA X+0 with the lowest ranking among the three logical addresses. The memory controller 200 stores the LBA X+2 at a head HEAD of the page buffer 630 and stores the other logical addresses according to rankings.

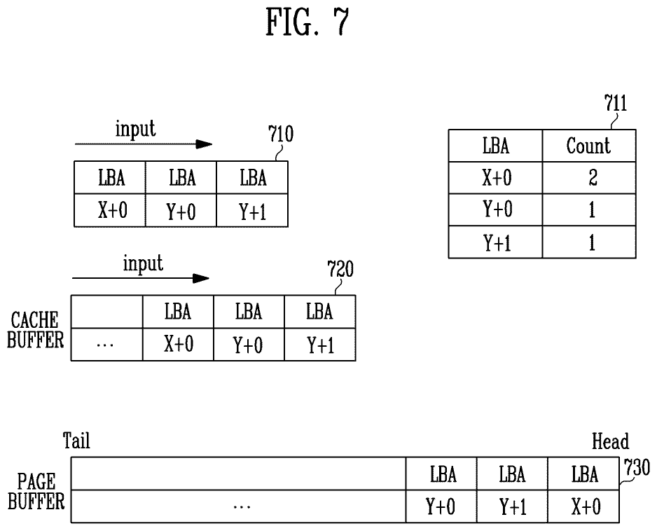

FIG. 7 includes tables showing re-ordering of logical addresses in accordance with an embodiment of the present disclosure.

Referring to FIG. 7, additional logical addresses 710 are received after the logical addresses 610 shown in FIG. 6 are received. The memory controller 200 generates a table 711 representing access numbers of the additional logical addresses 710.

The memory controller 200 stores the additional logical addresses 710 in a cache buffer 720 in an order in which the additional logical addresses 710 are received. The memory controller 200 re-orders the ranking of each of the logical addresses stored in the cache buffer 720. In FIG. 7, because an access number of LBA X+0 is two, the access number of LBA X+0 is highest among the additionally received logical addresses. Although the LBA X+0 is received first, the memory controller 200 changes the ranking of the logical address to the highest ranking because LBA X+0 has the highest access number. Because access numbers of LBA Y+0 and Y+1 are the same, a ranking of the LBA Y+1 that is received later than the LBA Y+0 is higher than a ranking of the LBA Y+0, similar to FIG. 6.

The memory controller 200 stores the re-ordered logical addresses in a page buffer 730. The memory controller 200 maps the re-ordered logical addresses to sequential area groups. The memory controller 100 stores the logical addresses mapped to the sequential area groups in a main buffer of the memory device 100. When the quantity of logical addresses stored in the main buffer reaches a threshold value, the memory device stores, in the sequential areas, data corresponding to the logical addresses stored in the main buffer.

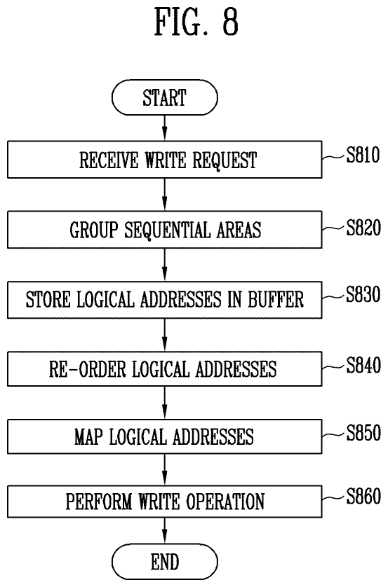

FIG. 8 is a flowchart illustrating a method of performing a write operation in accordance with an embodiment of the present disclosure.

Referring to FIG. 8, the memory system re-orders logical addresses received from the host device and maps the re-ordered logical address to sequential area groups after grouping sequential areas included in the memory device. Write performance of the memory device may be improved by re-ordering logical addresses.

The memory controller receives S810, from the host device, a write request including consecutive logical addresses and data corresponding to the logical addresses.

The memory controller groups S820 a plurality of sequential areas in which the data corresponding to the consecutive logical addresses are stored based on program speeds corresponding to the sequential areas. The memory controller groups the plurality of sequential areas such that sequential areas having a fast program speed are included in a hot group, sequential areas having a slow program speed are included in a cold group, and the other sequential areas, those sequential areas not included in the hot group or the cold group, are included in a warm group.

The memory controller stores S830 the received logical addresses in the buffer. The memory controller stores access numbers of the data based on or corresponding to the received logical addresses.

The memory controller re-orders S840 the ranking of each of the logical addresses stored in the buffer based on the access number and the access time of the data. When the access numbers of the data are the same, the memory controller determines ranking by identifying with the highest ranking the latest received logical address among the logical addresses with the same access number.

The memory controller maps S850 each of the re-ordered logical addresses to one of a hot group, a warm group, and a cold group. For example, the memory controller maps logical addresses to the hot group from the highest ranking of each of the logical addresses.

The memory device performs S860 a write operation corresponding to the write request based on the logical addresses mapped to one of the hot group, the warm group, and the cold group.

Descriptions of the processes of FIG. 8 correspond to various descriptions of FIG. 1, FIG. 2, FIG. 5, FIG. 6, and FIG. 7.

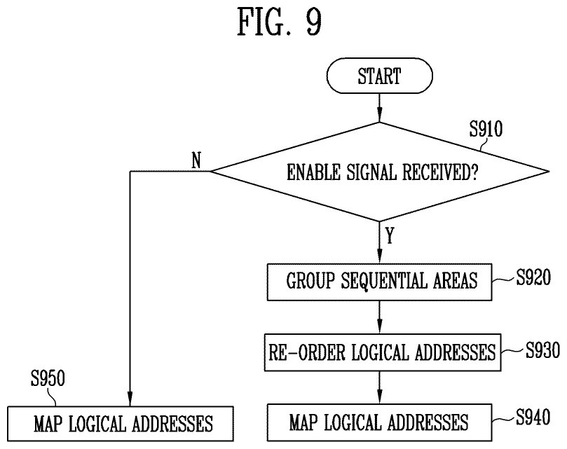

FIG. 9 is a flowchart illustrating logical address re-ordering performance in accordance with an embodiment of the present disclosure.

Referring to FIG. 9, the memory controller determines whether a re-ordering operation and a mapping operation on received logical addresses are to be performed according to whether an enable signal is received. The memory system performs an address mapping operation after a re-ordering operation when the enable signal is received, for example, from the host device 20, or performs a mapping operation of a logical address and a physical address when a disable signal is received, for example, from the host device 20.

The memory controller determines S910 whether an enable signal for a re-ordering operation is received, for example, from the host device 20. When the enable signal for the re-ordering operation is received by the memory controller 200, the memory controller 200 continues by performing grouping S920 the plurality of sequential areas in which the data corresponding to the consecutive logical addresses are stored based on program speeds corresponding to the sequential areas, re-ordering S930 the ranking of each of the logical addresses stored in the buffer based on the access number and the access time of the data, and mapping S940 each of the re-ordered logical addresses to one of a hot group, a warm group, and a cold group, for example, as described with respect to FIG. 8.

The memory controller performs S950 a mapping operation of a logical address and a physical address when a disable signal for the re-ordering operation is received, for example, from the host device 20. Because the re-ordering operation on received logical addresses is not performed, consecutive addresses are mapped to one of the sequential areas. The logical addresses are mapped regardless of program speeds of sequential areas of the memory device 10.

In an embodiment of the present disclosure, the performance of a write operation including re-ordering a ranking of each received logical addresses based on an access number and an access time of data and storing data in a mapped sequential area may be improved. For example, the program time of the write operation may be shortened. The size of map data representing a mapping relationship between a logical address and a physical address may be decreased. In accordance with the present disclosure, the overhead of the memory controller may be reduced. When the write operation is performed by re-ordering logical addresses and mapping the re-ordered logical addresses to sequential area groups grouped according to program speeds, data may be stored according to use frequencies (frequency of use) of the data. Data having a highest frequency of use is stored in a sequential area of the memory device having a fastest program speed, and data having a lowest frequency of frequency is stored in a sequential area having a slowest program speed. Accordingly, a background operation performed to secure a free block in the memory device is reduced, such that the lifetime of the memory device may be improved.

In accordance with the present disclosure, a memory system and a method for managing addresses of the memory system in which sequential areas having a highest program speed are mapped to data having a highest frequency of use when a write operation of the memory system is performed, thereby improving write performance.

In the embodiments, the processes of the method may be selectively performed or a subset of the processes and may be performed. In each embodiment, the processes are not necessarily performed in the order as described and may be rearranged. The embodiments disclosed in this specification and drawings are examples provided to facilitate understanding of the present disclosure, and the present disclosure is not limited to these examples or embodiments. Those skilled in the art understand that various modifications, additions, and substitutions are possible without departing from the technological scope of the present disclosure. The embodiments disclosed in the present specification should be considered from an illustrative standpoint and not a restrictive standpoint. Therefore, the scope of the present disclosure is not limited to the above descriptions. All changes within the meaning and range of equivalency of the claims are included within their scope.

What is claimed is:

1. A memory system comprising:
a memory device including a plurality of sequential areas in which data corresponding to consecutive logical addresses received from a host device are stored; and
a memory controller configured to receive, from the host device, a write request including the data and the logical addresses, to group the plurality of sequential areas into a plurality of sequential area groups based on a program speed corresponding to each of the plurality of sequential areas, and to map each of the logical addresses to one of the plurality of sequential area groups based on an access number and an access time of the data.

2. The memory system of claim 1, wherein the plurality of sequential area groups includes a hot group, a warm group, and a cold group, and
wherein the memory controller groups a first quantity of sequential areas as the hot group in an order in which the program speed is highest among the plurality of sequential areas, groups a second quantity of sequential areas as the cold group in an order in which the program speed is lowest among the plurality of sequential areas, and groups as the warm group other sequential areas, among the plurality of sequential areas, that are not included in the hot group or the cold group.

3. The memory system of claim 1, wherein the memory device includes memory cells stacked in a three-dimensional structure, and
wherein the program speed is determined based on a thickness of an oxide in which the memory cells are stacked.

4. The memory system of claim 2, wherein the memory controller stores logical addresses in a buffer in an order in which the logical addresses are received from the host device, and performs a re-ordering operation including determining a ranking of each of the logical addresses stored in the buffer based on the access number and the access time.

5. The memory system of claim 4, wherein the memory controller determines the ranking for each of the logical addresses in an order in which the access number having a highest value is assigned a highest ranking.

6. The memory system of claim 5, wherein the memory controller determines the ranking for each logical address among logical addresses having a same access number in an order in which the logical address last received from the host device is assigned a highest ranking.

7. The memory system of claim 4, wherein the memory controller maps a first quantity of logical addresses to the hot group in an order in which the ranking is highest among the re-ordered logical addresses, maps a second quantity of logical addresses to the cold group in an order in which the ranking is lowest among the re-ordered logical addresses, and maps to the warm group other logical addresses not included in the hot group or the cold group.

8. The memory system of claim 1, wherein the memory controller controls the memory device to perform a write operation corresponding to the write request based on the logical addresses mapped to the plurality of sequential area groups.

9. The memory system of claim 4, wherein the memory controller performs the re-ordering operation based on whether an enable signal for the re-ordering operation is received.

10. The memory system of claim 4, wherein the memory controller performs the re-ordering operation based on a size of the data.

11. The memory system of claim 10, wherein the memory controller maps logical addresses to the hot group when size of the data is smaller than a first limit value and maps logical addresses to the cold group when size of the data is greater than a second limit value greater than the first limit value.

12. The memory system of claim 4, wherein the memory controller performs the re-ordering operation based on a characteristic of the data.

13. The memory system of claim 12, wherein the memory controller maps logical addresses based on whether the data is journal data, map data, or firmware data.

14. A method of operating a memory system, the method comprising:
receiving, from a host device, a write request including consecutive logical addresses and data corresponding to the logical addresses to store the data in a memory device;
grouping each of a plurality of sequential areas of the memory device into one of a hot group, a warm group, and a cold group based on a program speed corresponding to each of the plurality of sequential areas; and
mapping each of the logical addresses to one of the hot group, the warm group, and the cold group based on an access number and an access time of the data.

15. The method of claim 14, wherein the grouping includes:
grouping, as the hot group, a first quantity of sequential areas having highest program speeds among the plurality of sequential areas;
grouping, as the cold group, a second quantity of sequential areas having lowest program speeds among the plurality of sequential areas; and
grouping, as the warm group, other sequential areas, among the plurality of sequential areas, that are not grouped in the hot group or the cold group.

16. The method of claim 14, wherein the mapping includes:
storing logical addresses in a buffer in an order in which the logical addresses are received from the host device; and
re-ordering a ranking of each of the logical addresses stored in the buffer based on the access number and the access time.

17. The method of claim 16, wherein the re-ordering includes:
determining the ranking for each of the logical addresses in an order in which the access number having a highest value is assigned a highest ranking; and
determining the ranking for each logical address among logical addresses having a same access number in an order in which the logical address last received from the host device is assigned a highest ranking.

18. The method of claim 16, wherein the mapping includes:
mapping a first quantity of logical addresses to the hot group in an order in which the ranking is highest among the re-ordered logical addresses;
mapping a second quantity of logical addresses to the cold group in an order in which the ranking is lowest among the re-ordered logical addresses; and
mapping to the warm group other logical addresses not included in the hot group or the cold group.

19. The method of claim 14, further comprising performing a write operation corresponding to the write request based on logical addresses mapped to one of the hot group, the warm group, and the cold group.

20. The method of claim 14, wherein the access number reflects frequency of use of the data.

21. A method comprising:
receiving a write request including logical addresses and data corresponding to the logical addresses to store the data in a memory device;
grouping, based on a program speed corresponding to each of a plurality of sequential areas of the memory device, each of the plurality of sequential areas into one of a plurality of sequential area groups; and
mapping each of the logical addresses to one of the sequential area groups based on frequency of use of the data.
